(19) United States
(12) Patent Application Publication
(10) Pub. No.: US 2023/0061036 A1
(43) Pub. Date: Mar. 2, 2023

(54) VEHICLE SEAT

(71) Applicant: Adient US LLC, Plymouth, MI (US)

(72) Inventors: Viktor ENNS, Kaiserslautern (DE); Christian WOLF, Dielkirchen (DE); Thomas DILL, Heiligenmoschel (DE); Darius WROBEL, Mehlingen (DE)

(21) Appl. No.: 17/823,550

(22) Filed: Aug. 31, 2022

(30) Foreign Application Priority Data
Sep. 2, 2021 (DE) 10 2021 122 552.3
May 24, 2022 (DE) 10 2022 104 918.3

(51) Int. Cl. B60N 2/42; B60N 2/04

(52) U.S. Cl. CPC B60N 2/4249; B60N 2/045

(57) ABSTRACT

A vehicle seat may have a seat substructure, at least one backrest, and a fastening arrangement for fastening the seat substructure to a base, in particular to a longitudinal adjuster. The seat substructure may have at least two side carriers and a transverse profile, in particular a front transverse tube, connected to the side carriers. The seat substructure may have at least one deformation element for limiting a force acting on the fastening arrangement, in particular a force introduced into the seat substructure via the transverse profile.

### FIELD

The invention relates to a vehicle seat, in particular for a minibus, the vehicle seat having a seat substructure, at least one backrest, and a fastening arrangement for fastening the seat substructure to a base, in particular to a longitudinal adjuster, the seat substructure having at least two side carriers and a transverse profile, in particular a front transverse tube, connected to the side carriers.

### BACKGROUND

The German patent application DE 10 2021 207 175.9 made on Jul. 7, 2021 discloses a fastening arrangement for fastening a vehicle seat to a rail arrangement, wherein the fastening arrangement is of modular construction and comprises at least one lock module for the releasable blocking of the fastening arrangement on the rail arrangement, a lock unlocking module and a rail unlocking module.

A fall arrester for arresting a falling body is disclosed in WO 02/063180 A1, which at a first end has a first connecting element for attaching the fall arrester to an anchor point and at a second end has a second connecting element for attaching the falling body. A fall arrester element between the two connecting elements is characterized by a rapid force absorption in the case of load in a first extension region. In a second extension region adjoining the first, the fall arrester element has a substantially uniform force absorption, in a third extension region adjoining the second, the fall arrester element has a force absorption which substantially increases and which ensures a smooth reduction in the fall speed without resulting damaging to the falling body and which in the case of overload absorbs the remaining forces of the arresting impact until the falling body comes to a standstill, wherein the length of the fall arrester element is increased by an extension length. The fall arrester element may be designed as a cord or a strap, in particular twisted, braided, knitted, or woven.

### SUMMARY

The object of the invention is to improve a vehicle seat with a fastening arrangement for fastening the vehicle seat to a base, in particular to a rail arrangement, in particular to protect the fastening arrangement from excessive loads in a crash case.

This object is achieved according to the invention by a vehicle seat, in particular for a minibus, the vehicle seat having a seat substructure, at least one backrest, and a fastening arrangement for fastening the seat substructure to a base, in particular to a longitudinal adjuster, the seat substructure having at least two side carriers and a transverse profile, in particular a front transverse tube, connected to the side carriers, wherein the seat substructure has at least one deformation element for limiting a force acting on the fastening arrangement, in particular a force introduced into the seat substructure via the front transverse profile.

As the seat substructure has at least one deformation element for limiting a force acting on the fastening arrangement, the fastening arrangement is protected from excessive forces in a crash case. As a result, the fastening arrangement may be designed cost-effectively. A force acting on the fastening arrangement, for example, results from a so-called submarining force which acts in the case of a front crash on the seat substructure, in particular on a front transverse profile of the seat substructure. The front transverse profile preferably acts as a so-called anti-submarining ramp.

Preferably, the deformation element is deformed together with further components of the seat substructure, in particular the side carriers.

The base may be a vehicle floor. The base may be a rail arrangement in a vehicle floor. The base may be a longitudinal adjuster. The base may be a longitudinal adjuster of the vehicle seat. The base may be a console.

The vehicle seat may be releasably fastenable by the fastening arrangement to a rail arrangement. Fastening arrangements for vehicle seats are known in the prior art. For example, the vehicle seat may be releasably fastened by hooks or screws to the rail arrangement.

Preferably, the fastening arrangement is of modular construction and comprises at least one lock module for the releasable blocking of the fastening arrangement to the rail arrangement, a lock unlocking module and a rail unlocking module.

The vehicle seat may have exactly one deformation element. The vehicle seat may have more than one deformation element. The vehicle seat may have exactly two deformation elements. When viewed in a transverse direction, the vehicle seat may have exactly one deformation element on both seat sides. The two deformation elements may be the same parts. The two deformation elements may be mirror-symmetrical. The two deformation elements may be arranged mirror-symmetrically to one another. The two deformation elements may be arranged mirror-symmetrically to a seat central plane.

The stiffness of the deformation element may increase with the increasing deformation of the deformation element. As a result, the situation is avoided that the seat substructure is able to dissipate a large amount of energy but is not able to be inadmissibly deformed to a significant degree. The stiffness of the deformation element may increase in a continuous manner with the increasing deformation of the deformation element. The stiffness of the deformation element may increase in a discontinuous manner with the increasing deformation of the deformation element. Preferably, the stiffness is lower in a first deformation phase than in a subsequent deformation phase. The first deformation phase may start in the undeformed three-dimensional state of the deformation element and end in a stretched, substantially two-dimensional state of the deformation element.

It is possible for the stiffness of the seat substructure to be able to be increased by an increase in the stiffness of the deformation element. Thus it is possible for the stiffness of the seat substructure to be able to be increased by a deformation of the deformation element, in particular beyond a first deformation phase.

The deformation element preferably acts as a strut. In an undeformed state of the strut, the strut may be shaped three-dimensionally. By the deformation, the strut may be deformed into an approximately two-dimensional shape. The stiffness of the strut increases when the approximately two-dimensional shape of the strut is reached.

The deformation element may be designed as a sheet metal component. The deformation element may be designed as a sheet steel component.

The deformation element may have a first end region, a second end region and a three-dimensional, in particular arcuate, deformation region arranged between the first end region and the second end region. The first end region, the second end region and the arcuate deformation region may be connected in one piece together. The deformation element may run diagonally.

A first end region of the deformation element may be connected to a front transverse profile of the seat substructure, in particular a front transverse tube of the seat substructure. A second end region of the deformation element may be connected to a carrier portion of the side carrier. A second end region of the deformation element may be connected to a rear transverse connection of the seat substructure.

The deformation element may be designed as a cord. In this case, straps and belts are to be understood by the term cord. The deformation element may have a cord. The deformation element may be produced from a cord. The deformation element may have a first cord end and a second cord end, wherein the first cord end is fixedly connected, in particular stitched, to the second cord end. The cord may connect a first component of the seat substructure, in particular a front transverse profile of an upper seat frame of the seat substructure, to a further component of the seat substructure, in particular a rear support part.

A deformation element having a cord or a deformation element which is designed as a cord may be connected by a cord knot, in particular an anchor knot, to a component of the seat substructure, in particular a front transverse profile of an upper seat frame. The deformation element having a cord or the deformation element designed as a cord may be connected by a connecting element, in particular by a sheet metal tab, to a component of the seat substructure, in particular a rear support part of a lower seat frame.

### DESCRIPTION OF THE FIGURES

The invention is described in more detail hereinafter with reference to two exemplary embodiments advantageously shown in the figures. The invention is not limited, however, to these exemplary embodiments. In the figures:

FIG. 1: shows a perspective view of a vehicle seat according to the invention according to a first exemplary embodiment, without upholstery,

FIG. 2: shows a side view of a seat substructure of the vehicle seat of FIG. 1,

FIG. 3: shows in a detail a perspective view of the vehicle seat of FIG. 1 in the region of a deformation element,

FIG. 4: shows a side view of a seat substructure of a vehicle seat according to the invention according to a second exemplary embodiment, without upholstery, and

FIG. 5: shows in a detail a perspective view of the vehicle seat of FIG. 4 in the region of a deformation element.

### DETAILED DESCRIPTION

The vehicle seats 1; 2 shown schematically in the figures are described hereinafter by using three spatial directions running perpendicular to one another. In a vehicle seat 1; 2 installed in the vehicle, a longitudinal direction x runs substantially horizontally and preferably parallel to a vehicle longitudinal direction, which corresponds to the usual direction of travel of the vehicle. A transverse direction y running perpendicularly to the longitudinal direction x is also horizontally oriented in the vehicle and runs parallel to a vehicle transverse direction. A vertical direction z runs perpendicularly to the longitudinal direction x and perpendicularly to the transverse direction y. In a vehicle seat 1; 2 installed in the vehicle, the vertical direction z runs parallel to the vehicle vertical axis.

The positional and directional information used, such as for example front, rear, top and bottom, relate to a viewing direction of an occupant seated in the vehicle seat 1; 2 in the normal seating position, wherein the vehicle seat 1; 2 is installed in the vehicle in a position of use suitable for passenger conveyance, with upright backrests 20 and is oriented in the direction of travel as is usual. Vehicle seats 1; 2 according to the invention, however, may also be installed in a different orientation, for example transversely to the direction of travel.

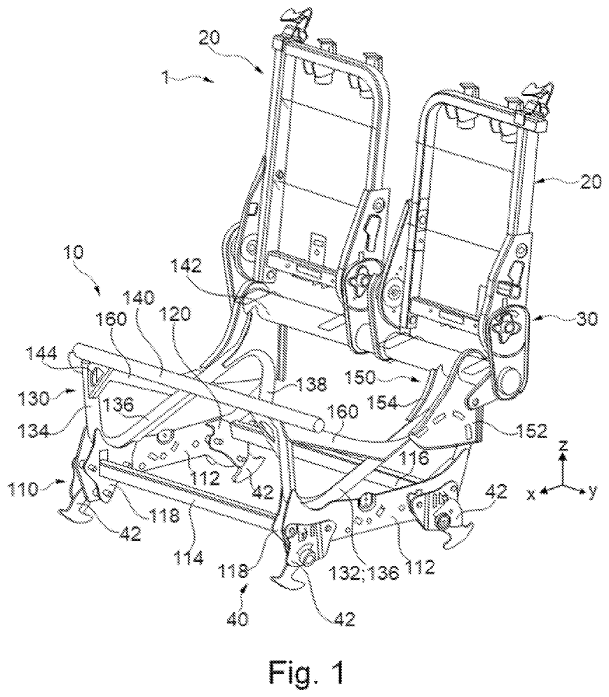

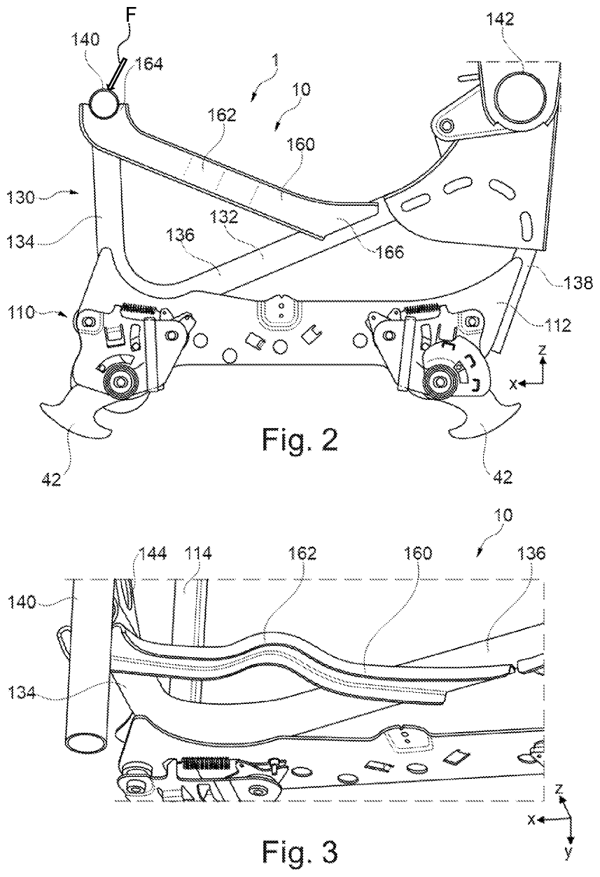

With reference to FIGS. 1 to 3, a vehicle seat 1 according to the invention is described hereinafter according to a first exemplary embodiment which is shown in the figures without upholstery.

The vehicle seat 1 has two seats. In particular, the vehicle seat is a 60% part of a longitudinally adjustable seat row of a minibus.

The vehicle seat 1 has a seat substructure 10 and two backrests 20. The two backrests 20 are connected in each case by two backrest adjusting fittings 30, in particular latching fittings or gear fittings, to the seat substructure 10.

The seat substructure 10 is connectable by a fastening arrangement 40 comprising four lock modules 42, to a base, in particular a longitudinal adjuster.

The seat substructure 10 has a lower seat frame 110 and an upper seat frame 130. The lower seat frame 110 is fixedly connected to the upper seat frame 130.

The lower seat frame 110 has two seat frame side parts 112 which are arranged spaced apart from one another in the transverse direction y. The two seat frame side parts 112 are connected together by a front transverse connection 114, in the present case a square tube, and a rear transverse connection 116, in the present case a further square tube.

The two ends of the front transverse connection 114 are connected, preferably welded, in each case to one of the two seat frame side parts 112. Additionally, in each case a front support part 118, in the present case a sheet metal part, is arranged in the two end regions of the front transverse connection 114. The two front support parts 118 are fastened in each case by a plurality of spacer pins, respectively to one assigned seat frame side part 112. The front transverse connection 114 runs in each case on either side through an opening in the front support parts 118 and is preferably welded to the front support parts 118.

The two ends of the rear transverse connection 116 in each case are connected, preferably welded, to one of the two seat frame side parts 112. Additionally, in each case a rear support part 120, in the present case a sheet metal part, is arranged in the two end regions of the rear transverse connection 116. The two rear support parts 120 are fastened in each case by a plurality of spacer pins, respectively to one assigned seat frame side part 112. The rear transverse connection 116 is located in each case in a recess in the rear support parts 120 and is preferably welded to the rear support parts 120.

The upper seat frame 130 has two side carriers 132, a front transverse profile 140, in the present case configured as a tube, and a rear transverse profile 142, in the present case also configured as a tube. The front transverse profile 140 is connected in each case on either side by a gusset plate 144 to the side carriers 132.

Both side carriers 132 are designed in the present case as a one-piece, curved tube, in particular steel tube. Both side carriers 132 have in each case a first carrier portion 134, in particular a first tube portion, a second carrier portion 136, in particular a second tube portion, and a third carrier portion 138, in particular a third tube portion.

The carrier portions 134, 136, 138 run in each case substantially linearly. Each side carrier 132 has in each case curved transition regions, in particular made of steel tube, between the first carrier portion 134 and the second carrier portion 136 and between the second carrier portion 136 and the third carrier portion 138. The front transverse profile 140 is connected in each case on either side by a gusset plate 144 to an upper end region of the assigned first carrier portion 134.

The two first carrier portions 134 run in each case substantially parallel or at an acute angle to the vertical direction z. The two third carrier portions 138 run in each case substantially parallel or at an acute angle to the vertical direction z. The two second carrier portions 136 run in each case obliquely between a lower end region of a first carrier portion 134 and an upper end region of a third carrier portion 138. The two first side carriers 132 are in each case z-shaped.

The transition regions between the first carrier portions 134 and the second carrier portions 136 are arranged in each case between a seat frame side part 112 and a front support part 118, and preferably welded thereto. The transverse regions between the second carrier portions 136 and the third carrier portions 138 are arranged in each case between an outer connecting plate 152 and an inner connecting plate 154 of a connecting device 150 and preferably welded thereto. The connecting device 150 connects the rear transverse profile 142 to the upper seat frame 130 and to the backrest adjusting fittings 30.

The seat substructure 10 has in each case on either side a deformation element 160. From a limit load, the two deformation elements 160 deform together with further components of the seat substructure 10, in particular the side carriers 132, and thereby protect the lock modules 42 from excessive loading, in particular in the case of a front crash in which so-called submarining forces are introduced into the front transverse profile 140 by one occupant or two occupants of the vehicle seat 1.

Energy is dissipated by a targeted deformation of the deformation elements 160 and the side carriers 132, whereby less energy reaches the lock modules 42.

To avoid an excessive deformation of the seat substructure 10, the stiffness of the deformation element 160 increases after a defined deformation of the deformation element 160, so that the deformation of the seat substructure 10 as a whole is limited. In this case, however, the loading of the lock modules 42 remains below a permitted limit load of the lock modules 42.

Only one deformation element 160 is described hereinafter. The vehicle seat 1, however, is constructed substantially mirror-symmetrically so that the description also relates to the other deformation element 160.

The deformation element 160 has a substantially elongated extension. The deformation element 160 has a substantially C-shaped cross section perpendicular to its direction of extension. The deformation element 160 has a first end region 164 and a second end region 166. Between the first end region 164 and the second end region 166 the deformation element 160 has a three-dimensional arcuate portion as a deformation region 162. The deformation region 162 is preferably configured in the transverse direction y. By the structural design of the deformation region 162 the stiffness of the deformation region 162 may be structurally adjusted as a function of the deformation of the deformation region 162.

The first end region 164 of the deformation element 160 has a fork-shaped receiver for the front transverse profile 140. The first end region 164 of the deformation element 160 is connected, preferably welded, in the region of the fork-shaped receiver to the front transverse profile 140. The first end region 164 of the deformation element 160 may also be connected, preferably welded, to the first carrier portion 134 of the side carrier 132. The second end region 166 of the deformation element 160 is connected, preferably welded, to the second carrier portion 136 of the side carrier 132.

The deformation element 160 acts as a strut. Under high load, in particular with a (submarining) force F introduced into the front transverse profile 140, a high tensile load acts on the deformation element 160 and thus on the deformation region 162 of the deformation element 160, which plastically deforms the deformation region 162. In the present case, the arcuate deformation region 162 is deformed under high load to form a substantially linear portion. The plastic deformation of the deformation element 160 preferably takes place in combination with a deformation of further components of the seat substructure 10, in particular in combination with a deformation of the side carriers 132.

As soon as the deformation region 162 of the deformation element 160 is deformed to form a substantially linear region, the deformation region 162 is stiffer than before the deformation thereof, whereby the deformation element 160 may absorb increasingly high loads without further deformation. As a result, notwithstanding the described load relief of the lock modules 42, an inadmissibly high deformation of the seat substructure 10 is avoided.

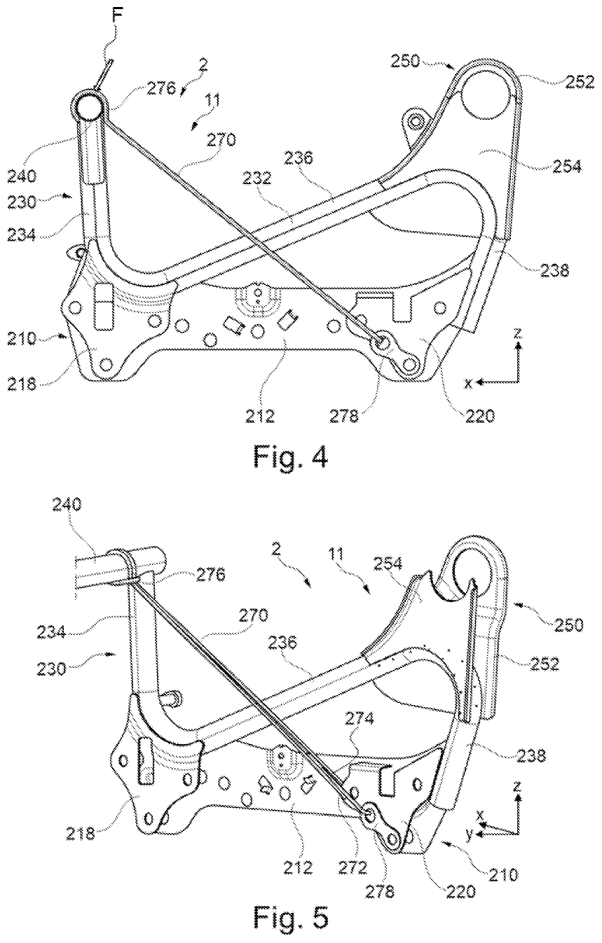

FIGS. 4 and 5 show in a detail a vehicle seat 2 according to the invention according to a second exemplary embodiment, which is shown in FIGS. 4 and 5 without upholstery. The vehicle seat 2 regarding its structure and its function corresponds to the above-described vehicle seat 1 of the first exemplary embodiment, provided it is not described differently below. The components, not shown in FIGS. 4 and 5, namely the backrest, backrest adjusting fitting, fastening arrangement and lock module, correspond to the above-described components of the vehicle seat 1 of the first exemplary embodiment.

The vehicle seat 2 has two seats. In particular, the vehicle seat 2 is a 60% part of a longitudinal adjustable seat row of a minibus.

The vehicle seat 2 has a seat substructure 11 and two backrests. The two backrests are connected in each case by two backrest adjusting fittings to the seat substructure 11. The seat substructure 11 is connectable by a fastening arrangement comprising four lock modules to a base, in particular a longitudinal adjuster.

The seat substructure 11 has a lower seat frame 210 and an upper seat frame 230. The lower seat frame 210 is fixedly connected to the upper seat frame 230.

The lower seat frame 210 has two seat frame side parts 212 which are arranged spaced apart from one another in the transverse direction y. The two seat frame side parts 212 are connected together by a front transverse connection, for example a square tube, and a rear transverse connection, for example a further square tube.

The two ends of the front transverse connection in each case are welded to one of the two seat frame side parts 212. In each case a front support part 218 is also arranged in the two end regions of the front transverse connection. The two front support parts 218 are fastened in each case by a plurality of spacer pins, respectively to one assigned seat frame side part 212. The front transverse connection runs in each case on either side through an opening in the front support parts 218 and is preferably welded to the front support parts 218.

The two ends of the rear transverse connection are connected in each case, preferably welded, to one of the two seat frame side parts 212. In each case, a rear support part 220 is also arranged in the two end regions of the rear transverse connection. The two rear support parts 220 are fastened in each case by a plurality of spacer pins to one respectively assigned seat frame side part 212. The rear transverse connection is located in each case in a recess in the rear support parts 220 and is preferably welded to the rear support parts 220.

The upper seat frame 230 has two side carriers 232, a front transverse profile 240 and a rear transverse profile, not shown in FIGS. 4 and 5. The front transverse profile 240 is connected on either side to the side carriers 232.

Both side carriers 232 in the present case are designed in each case as a one-piece, curved tube, in particular steel tube. Both side carriers 232 have in each case a first carrier portion 234, a second carrier portion 236, and a third carrier portion 238. A transition region between the first carrier portions 234 and the second carrier portions 236 is arranged in each case between a seat frame side part 212 and a front support part 218 and preferably welded thereto. In each case, a transition region between the second carrier portions 236 and the third carrier portions 238 is arranged between an outer metal connecting plate 252 and an inner metal connecting plate 254 of a connecting device 250 and preferably welded thereto.

The seat substructure 11 has in each case on either side a deformation element 270. The two deformation elements 270 act in each case as a strut and from a limit load deform together with further components of the seat substructure 11, in particular the side carriers 232, and thereby protect the lock modules from excessive load, in particular in the case of a front crash, in which so-called submarining forces are introduced into the front transverse profile 240 by one occupant or two occupants of the vehicle seat 2. Energy is dissipated by a targeted deformation of the deformation elements 270 and the side carriers 232, whereby less energy reaches the lock modules.

To avoid excessive deformation of the seat substructure 11, the stiffness of the deformation element 270 increases after a defined deformation of the deformation element 270, so that the deformation of the seat substructure 11 is limited as a whole. The loading of the lock modules, however, remains below a permitted limit load of the lock modules.

Only one deformation element 270 is described hereinafter. The vehicle seat 2, however, is constructed substantially mirror-symmetrically, so that the description also relates to the other deformation element 270.

The deformation element 270 comprises a cord. A first cord end 272 and a second cord end 274 are connected together, in particular stitched. The deformation element 270 is connected by a cord knot 276, in the present case by a so-called anchor knot, to the front transverse profile 240 of the upper seat frame 230. In addition, the deformation element 270 is connected to the rear support part 220 of the lower seat frame 210. To this end, the cord of the deformation element 270 is passed through a tab 278 which is screwed to the rear support part 220.

The deformation element 270 preferably comprises a cord, as is used in the prior art as a fall arrester element, for example as disclosed in WO 02/063180 A1. In particular, the deformation element 270 comprises a folded-up, stitched cord, the seams thereof tearing when under stress and thereby dissipating energy with the lengthening (deformation) of the cord. In the present case, the cord has an approximately circular cross section with a diameter of 2 mm to 10 mm, preferably 5 mm. The term cord, however, is also intended to be understood to mean flat straps, in particular flat straps with an approximately rectangular cross section.

The features disclosed in the above description, the claims and the figures may be important both individually and in combination for implementing the invention in its various embodiments, provided they remain within the protected scope of the claims.

### LIST OF REFERENCE NUMERALS

1; 2 Vehicle seat
10; 11 Seat substructure
20 Backrest
30 Backrest adjusting fitting
40 Fastening arrangement
42 Lock module
110; 210 Lower seat frame
112; 212 Seat frame side part
114 Front transverse connection
116 Rear transverse connection
118; 218 Front support part
120; 220 Rear support part
130; 230 Upper seat frame
132; 232 Side carrier, tube profile
134; 234 First carrier portion, first tube portion
136; 236 Second carrier portion, second tube portion
138; 238 Third carrier portion, third tube portion
140; 240 (Front) transverse profile
142 (Rear) transverse profile
144 Gusset plate
150; 250 Connecting device
152; 252 Outer metal connecting plate
154; 254 Inner metal connecting plate
160 Deformation element
162 Deformation region, arcuate portion
164 First end region
166 Second end region
270 Deformation element, cord
272 First cord end
274 Second cord end
276 Cord knot
278 Tab
F Force
x Longitudinal direction
y Transverse direction
z Vertical direction

1-10. (canceled)

11. A vehicle seat, comprising:
a seat substructure,
at least one backrest, and
a fastening arrangement for fastening the seat substructure to a longitudinal adjuster,
wherein the seat substructure has at least two side carriers and a front transverse tube connected to the side carriers wherein the seat substructure has at least one deformation element for limiting a force acting on the fastening arrangement, wherein the force is introduced into the seat substructure via the transverse profile.

12. The vehicle seat according to claim 11, wherein the stiffness of the deformation element is able to be increased by a deformation of the deformation element.

13. The vehicle seat according to claim 11, wherein the stiffness of the seat substructure is able to be increased by a deformation of the at least one deformation element.

14. The vehicle seat according to claim 11, wherein the at least one deformation element acts as a strut.

15. The vehicle seat according to claim 11, wherein the at least one deformation element is designed as a sheet metal component.

16. The vehicle seat according to claim 15, wherein the sheet metal component is a sheet steel component.

17. The vehicle seat according to claim 11, wherein the at least one deformation element has a first end region, a second end region and a three-dimensional, arcuate, deformation region arranged between the first end region and the second end region.

18. The vehicle seat according to claim 11, wherein the at least one deformation element has a cord or is designed as a cord.

19. The vehicle seat according to claim 18, wherein the at least one deformation element has a first cord end and a second cord end, wherein the first cord end is fixedly connected to the second cord end.

20. The vehicle seat according to claim 19, wherein the first cord end is stitched to the second cord end.

21. The vehicle seat according claim 17, wherein the at least one deformation element connects a first component of the seat substructure comprising a front transverse profile of an upper seat frame of the seat substructure, to a further component of the seat substructure.

22. The vehicle seat according to claim 21, wherein the seat substructure is a rear support part.

23. The vehicle seat according to claim 21, wherein the deformation element is connected by at least one cord knot to one of the components of the seat substructure.

24. The vehicle seat according to claim 23, wherein the at least one cord knot is an anchor knot connected to a front transverse tube of an upper seat frame.
